(19) United States
(12) Patent Application Publication
(10) Pub. No.: US 2009/0319916 A1
(43) Pub. Date: Dec. 24, 2009

(54) TECHNIQUES TO AUTO-ATTEND MULTIMEDIA CONFERENCE EVENTS

(75) Inventors: Ananta S. Gudipaty, Redmond, WA (US); Avronil Bhattacharjee, Redmond, WA (US); Pulin Thakkar, Redmond, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/144,650

(22) Filed: Jun. 24, 2008

(51) Int. Cl. G06F 3/048

(52) U.S. Cl. 715/753

(57) ABSTRACT

Techniques to auto-attend multimedia conference events are described. An apparatus may comprise a recording management component operative to manage recording and reproduction operations for a multimedia conference event. The recording management component may comprise, among other elements, an event handler module operative to receive an auto-attend request from a meeting invitee as an auto-attendee for a multimedia conference event. The recording management component may also include an event schedule module communicatively coupled to the event handler module, the event schedule module operative to schedule the multimedia conference event for automatic recording operations in response to the auto-attend request. The recording management component may further include an event capture module communicatively coupled to the event schedule module, the event capture module operative to record the multimedia conference event to form a recorded meeting event file for the auto-attendee. Other embodiments are described and claimed.

### BACKGROUND

A multimedia conference system typically allows multiple participants to communicate and share different types of media content in a collaborative and real-time meeting over a network. The multimedia conference system may display different types of media content using various graphical user interface (GUI) windows or views. For example, one GUI view might include video images of participants, another GUI view might include presentation slides, yet another GUI view might include text messages between participants, and so forth. In this manner various geographically disparate participants may interact and communicate information in a virtual meeting environment similar to a physical meeting environment where all the participants are within one room.

Recording is a core component of many multimedia conference systems as it provides asynchronous access to the content and proceedings of a meeting. High level usage scenarios include creating training material or prepared presentations for reuse or broad distribution, preserving material and context for an absent attendee, archiving for offline note-taking or preserving discussions, and archiving content for compliance with various rules and laws. Such usage scenarios are typically driven by the assumption that meeting content and discussions have value beyond the meeting, and therefore could be preserved for access and use afterwards. Consequently, improvements to recording management techniques may enhance the value of recordings for these and other usage scenarios.

### SUMMARY

Various embodiments may be generally directed to multimedia conference systems. Some embodiments may be particularly directed to techniques to manage recordings for a multimedia conference event. The multimedia conference event may include multiple participants, some of which may gather in a conference room, while others may participate in the multimedia conference event from a remote location.

In one embodiment, for example, an apparatus may comprise a recording management component operative to manage recording and reproduction operations for a multimedia conference event. The recording management component may comprise, among other elements, an event handler module operative to receive an auto-attend request from a meeting invitee as an auto-attendee for a multimedia conference event. The recording management component may also include an event schedule module communicatively coupled to the event handler module, the event schedule module operative to schedule the multimedia conference event for automatic recording operations in response to the auto-attend request. The recording management component may further include an event capture module communicatively coupled to the event schedule module, the event capture module operative to record the multimedia conference event to form a recorded meeting event file for the auto-attendee. Other embodiments are described and claimed.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates an embodiment of a multimedia conference system.

FIG. 2 illustrates an embodiment of a recording management component.

FIG. 3 illustrates an embodiment of a meeting view.

FIG. 4 illustrates an embodiment of a logic flow.

FIG. 5 illustrates an embodiment of a computing architecture.

FIG. 6 illustrates an embodiment of an article.

### DETAILED DESCRIPTION

Various embodiments include physical or logical structures arranged to perform certain operations, functions or services. The structures may comprise physical structures, logical structures or a combination of both. The physical or logical structures are implemented using hardware elements, software elements, or a combination of both. Descriptions of embodiments with reference to particular hardware or software elements, however, are meant as examples and not limitations. Decisions to use hardware or software elements to actually practice an embodiment depends on a number of external factors, such as desired computational rate, power levels, heat tolerances, processing cycle budget, input data rates, output data rates, memory resources, data bus speeds, and other design or performance constraints. Furthermore, the physical or logical structures may have corresponding physical or logical connections to communicate information between the structures in the form of electronic signals or messages. The connections may comprise wired and/or wireless connections as appropriate for the information or particular structure. It is worthy to note that any reference to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

Various embodiments may be generally directed to multimedia conference systems arranged to provide meeting and collaboration services to multiple participants over a network. Some multimedia conference systems may be designed to operate with various packet-based networks, such as the Internet or World Wide Web (“web”), to provide web-based conferencing services. Such implementations are sometimes referred to as web conferencing systems. An example of a web conferencing system may include MICROSOFT® OFFICE LIVE MEETING made by Microsoft Corporation, Redmond, Wash. Other multimedia conference systems may be designed to operate for a private network, business, organization, or enterprise, and may utilize a multimedia conference server such as MICROSOFT OFFICE COMMUNICATIONS SERVER made by Microsoft Corporation, Redmond, Wash. It may be appreciated, however, that implementations are not limited to these examples.

A multimedia conference system may include, among other network elements, a multimedia conference server or other processing device arranged to provide web conferencing services. For example, a multimedia conference server may include, among other server elements, a server meeting component operative to control and mix different types of media content for a meeting and collaboration event, such as a web conference. A meeting and collaboration event may refer to any multimedia conference event offering various types of multimedia information in a real-time or live online environment, and is sometimes referred to herein as simply a “meeting event,” “multimedia event” or “multimedia conference event.”

In one embodiment, the multimedia conference system may further include one or more computing devices implemented as meeting consoles. Each meeting console may be arranged to participate in a multimedia event by connecting to the multimedia conference server. Different types of media information from the various meeting consoles may be received by the multimedia conference server during the multimedia event, which in turn distributes the media information to some or all of the other meeting consoles participating in the multimedia event As such, any given meeting console may have a display with multiple media content views of different types of media content. In this manner various geographically disparate participants may interact and communicate information in a virtual meeting environment similar to a physical meeting environment where all the participants are within one room.

In the fast paced modern workplaces, it is very common for many to have a day full of meetings with numerous schedule conflicts and overlapping meetings. At least some, if not a significant portion, of these meetings are more for information gathering than participation. For example, an engineer may attend a marketing meeting to understand the competitive landscape and segmentation. The engineer is likely to be a silent participant in the meeting, gathering information as opposed to contributing information. When a conflict arises, the engineer is likely to skip the information gathering meeting and opt for another sessions where his or her active participation is needed. In this process, the engineer has lost some valuable information that can have detrimental consequences to the productivity of the overall organization. Another similar scenario occurs when a participant cares about only one topic in a meeting with multiple items in the agenda. The participant is frequently forced to sit through the entire meeting for his or her single topic of interest, causing a loss in his or her productivity. In the worst case, due to extensive deliberations on another topic, the meeting may not even address the topic of interest, thereby completely wasting the participant's time.

For these and other reasons, recording is a core component of many multimedia conference systems as it provides asynchronous access to the content and proceedings of a meeting. High level usage scenarios include creating training material or prepared presentations for reuse or broad distribution, preserving material and context for an absent attendee, archiving for offline note-taking or preserving discussions, and archiving content for compliance with various rules and laws. Such usage scenarios are typically driven by the assumption that meeting content and discussions have value beyond the meeting, and therefore could be preserved for access and use afterwards.

Conventional recording management techniques, however, are unsatisfactory for a number of reasons. For example, to record a multimedia conference event by a meeting console for an absent invitee, the absent invitee typically needs to join the multimedia conference event, and manually select a recording feature from a user interface. This may be tedious for the absent invitee, and in some cases, inconvenient or impossible when the absent invitee is not near a meeting console when the multimedia conference event begins. In another example, to record a multimedia conference event using a meeting console for a meeting participant, the absent invitee needs to coordinate with the meeting participant prior to the start of the multimedia conference event. The absent invitee would need to request the meeting participant to manually record the multimedia conference event at the meeting console for the meeting participant, and then send a recorded meeting event file from the meeting console to the absent invitee.

To solve these and other problems, the embodiments are generally directed to various enhanced recording management techniques. Some embodiments are particularly directed to auto-attend techniques that allow a meeting invitee to automatically attend a multimedia conference event. A meeting invitee may receive a meeting invite for a multimedia conference event, and find that they are unable or unwilling to accept the meeting invite for any number of different reasons. The meeting invitee, however, may still desire to review the information provided by the multimedia conference event. In this case, the meeting invitee can optionally request that the multimedia conference event be automatically recorded and sent to the meeting invitee.

The auto-attend techniques may be implemented in various network devices in a communications system. In one embodiment, for example, the auto-attend techniques may be implemented by a network device such as a multimedia conference server. This may have the advantage of completely automating the recording and notification operations while reducing or eliminating the need for manual operations by meeting participants. In one embodiment, for example, the auto-attend techniques may be implemented by a network device such as a meeting console for a meeting participant. In this case, a meeting console for a meeting participant such as a meeting organizer may be notified of the auto-attendee, and may automatically record the multimedia conference event and send to the auto-attendee. In one embodiment, for example, the auto-attend techniques may be implemented by a network device such as a meeting console for the auto-attendee. In this case, the meeting console for the auto-attendee will need to be online and available to automatically join the multimedia conference event, and initiate recording operations.

Additionally or alternatively, the auto-attend techniques may also provide information for presentation to the meeting participants. An auto-attendee may desire to submit some materials for review by the meeting participants during the multimedia conference event, ask a question on an agenda topic, and so forth. In the former case, the auto-attendee may send along an auto-attend file with the request to auto-attend a multimedia conference event, and user parameters detailing when the file should be presented. The multimedia conference server or the meeting console may automatically present the auto-attend file at the appropriate time on behalf of the auto-attendee, or provide the auto-attend file in a common share for the meeting participants. In some cases, a meeting participant such as the meeting organizer may manually present the auto-attend file at the appropriate time on behalf of the auto-attendee.

As a result of auto-attend techniques, auto-attendees may more effectively schedule and record multimedia conference events to consume information from such events. Furthermore, the auto-attendees may provide information to the multimedia conference events when not actually present at such events, thereby adding value to the multimedia conference events.

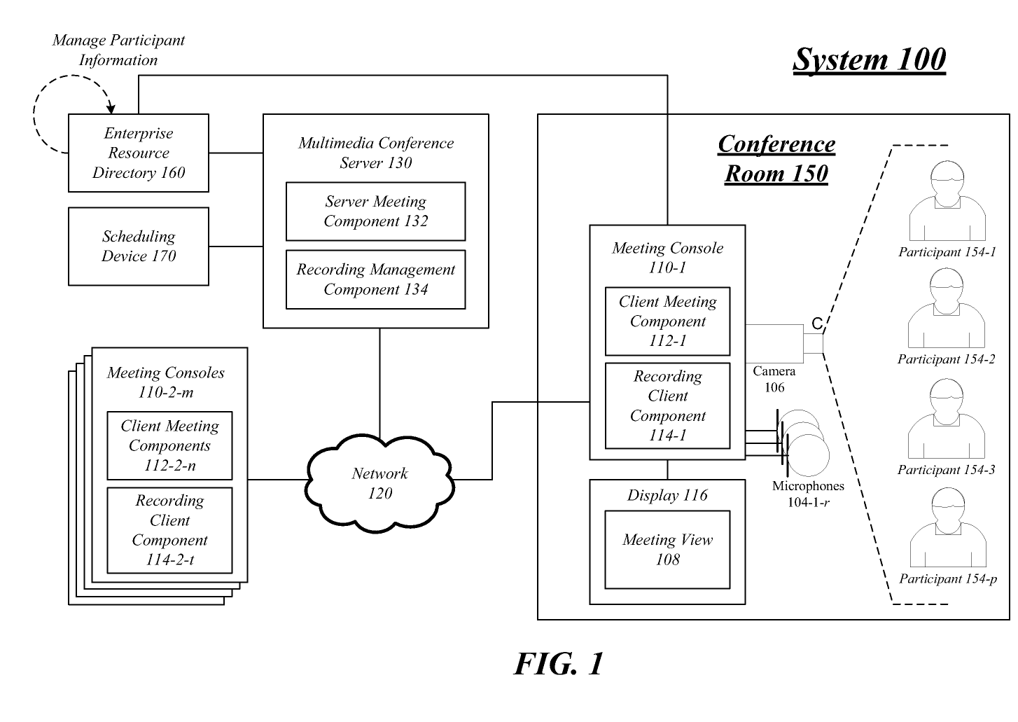

FIG. 1 illustrates a block diagram for a multimedia conference system 100. Multimedia conference system 100 may represent a general system architecture suitable for implementing various embodiments. Multimedia conference system 100 may comprise multiple elements. An element may comprise any physical or logical structure arranged to perform certain operations. Each element may be implemented as hardware, software, or any combination thereof, as desired for a given set of design parameters or performance constraints. Examples of hardware elements may include devices, components, processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software may include any software components, programs, applications, computer programs, application programs, system programs, machine programs, operating system software, middleware, firmware, software modules, routines, subroutines, functions, methods, interfaces, software interfaces, application program interfaces (API), instruction sets, computing code, computer code, code segments, computer code segments, words, values, symbols, or any combination thereof. Although multimedia conference system 100 as shown in FIG. 1 has a limited number of elements in a certain topology, it may be appreciated that multimedia conference system 100 may include more or less elements in alternate topologies as desired for a given implementation. The embodiments are not limited in this context.

In various embodiments, the multimedia conference system 100 may comprise, or form part of, a wired communications system, a wireless communications system, or a combination of both. For example, the multimedia conference system 100 may include one or more elements arranged to communicate information over one or more types of wired communications links. Examples of a wired communications link may include, without limitation, a wire, cable, bus, printed circuit board (PCB), Ethernet connection, peer-to-peer (P2P) connection, backplane, switch fabric, semiconductor material, twisted-pair wire, co-axial cable, fiber optic connection, and so forth. The multimedia conference system 100 also may include one or more elements arranged to communicate information over one or more types of wireless communications links. Examples of a wireless communications link may include, without limitation, a radio channel, infrared channel, radio-frequency (RF) channel, Wireless Fidelity (WiFi) channel, a portion of the RF spectrum, and/or one or more licensed or license-free frequency bands.

In various embodiments, the multimedia conference system 100 may be arranged to communicate, manage or process different types of information, such as media information and control information. Examples of media information may generally include any data representing content meant for a user, such as voice information, video information, audio information, image information, textual information, numerical information, application information, alphanumeric symbols, graphics, and so forth. Media information may sometimes be referred to as “media content” as well. Control information may refer to any data representing commands, instructions or control words meant for an automated system. For example, control information may be used to route media information through a system, to establish a connection between devices, instruct a device to process the media information in a predetermined manner, and so forth.

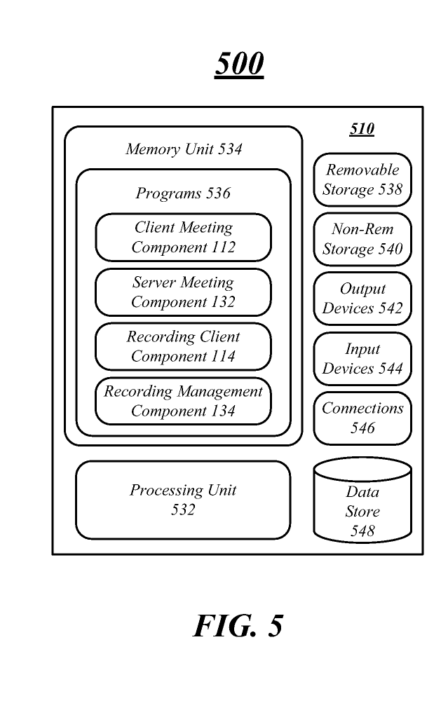

In various embodiments, multimedia conference system 100 may include a multimedia conference server 130. The multimedia conference server 130 may comprise any logical or physical entity that is arranged to establish, manage or control a multimedia conference call between meeting consoles 110-1-m over a network 120. Network 120 may comprise, for example, a packet-switched network, a circuit-switched network, or a combination of both. In various embodiments, the multimedia conference server 130 may comprise or be implemented as any processing or computing device, such as a computer, a server, a server array or server farm, a work station, a mini-computer, a main frame computer, a supercomputer, and so forth. The multimedia conference server 130 may comprise or implement a general or specific computing architecture suitable for communicating and processing multimedia information. In one embodiment, for example, the multimedia conference server 130 may be implemented using a computing architecture as described with reference to FIG. 5. Examples for the multimedia conference server 130 may include without limitation a MICROSOFT OFFICE COMMUNICATIONS SERVER, a MICROSOFT OFFICE LIVE MEETING server, and so forth.

A specific implementation for the multimedia conference server 130 may vary depending upon a set of communication protocols or standards to be used for the multimedia conference server 130. In one example, the multimedia conference server 130 may be implemented in accordance with the Internet Engineering Task Force (IETF) Multiparty Multimedia Session Control (MMUSIC) Working Group Session Initiation Protocol (SIP) series of standards and/or variants. SIP is a proposed standard for initiating, modifying, and terminating an interactive user session that involves multimedia elements such as video, voice, instant messaging, online games, and virtual reality. In another example, the multimedia conference server 130 may be implemented in accordance with the International Telecommunication Union (ITU) H.323 series of standards and/or variants. The H.323 standard defines a multipoint control unit (MCU) to coordinate conference call operations. In particular, the MCU includes a multipoint controller (MC) that handles H.245 signaling, and one or more multipoint processors (MP) to mix and process the data streams. Both the SIP and H.323 standards are essentially signaling protocols for Voice over Internet Protocol (VoIP) or Voice Over Packet (VOP) multimedia conference call operations. It may be appreciated that other signaling protocols may be implemented for the multimedia conference server 130, however, and still fall within the scope of the embodiments.

In general operation, multimedia conference system 100 may be used for multimedia conference calls. Multimedia conference calls typically involve communicating voice, video, and/or data information between multiple end points. For example, a public or private packet network 120 may be used for audio conferencing calls, video conferencing calls, audio/video conferencing calls, collaborative document sharing and editing, and so forth. The packet network 120 may also be connected to a Public Switched Telephone Network (PSTN) via one or more suitable VoIP gateways arranged to convert between circuit-switched information and packet information.

To establish a multimedia conference call over the packet network 120, each meeting console 110-1-m may connect to multimedia conference server 130 via the packet network 120 using various types of wired or wireless communications links operating at varying connection speeds or bandwidths, such as a lower bandwidth PSTN telephone connection, a medium bandwidth DSL modem connection or cable modem connection, and a higher bandwidth intranet connection over a local area network (LAN), for example.

In various embodiments, the multimedia conference server 130 may establish, manage and control a multimedia conference call between meeting consoles 110-1-m. In some embodiments, the multimedia conference call may comprise a live web-based conference call using a web conferencing application that provides full collaboration capabilities. The multimedia conference server 130 operates as a central server that controls and distributes media information in the conference. It receives media information from various meeting consoles 110-1-m, performs mixing operations for the multiple types of media information, and forwards the media information to some or all of the other participants. One or more of the meeting consoles 110-1-m may join a conference by connecting to the multimedia conference server 130. The multimedia conference server 130 may implement various admission control techniques to authenticate and add meeting consoles 110-1-m in a secure and controlled manner.

In various embodiments, the multimedia conference system 100 may include one or more computing devices implemented as meeting consoles 110-1-m to connect to the multimedia conference server 130 over one or more communications connections via the network 120. For example, a computing device may implement a client application that may host multiple meeting consoles each representing a separate conference at the same time. Similarly, the client application may receive multiple audio, video and data streams. For example, video streams from all or a subset of the participants may be displayed as a mosaic on the participant's display with a top window with video for the current active speaker, and a panoramic view of the other participants in other windows.

The meeting consoles 110-1-m may comprise any logical or physical entity that is arranged to participate or engage in a multimedia conference call managed by the multimedia conference server 130. The meeting consoles 110-1-m may be implemented as any device that includes, in its most basic form, a processing system including a processor and memory, one or more multimedia input/output (I/O) components, and a wireless and/or wired network connection. Examples of multimedia I/O components may include audio I/O components (e.g., microphones, speakers), video I/O components (e.g., video camera, display), tactile (I/O) components (e.g., vibrators), user data (I/O) components (e.g., keyboard, thumb board, keypad, touch screen), and so forth. Examples of the meeting consoles 110-1-m may include a telephone, a VoIP or VOP telephone, a packet telephone designed to operate on the PSTN, an Internet telephone, a video telephone, a cellular telephone, a personal digital assistant (PDA), a combination cellular telephone and PDA, a mobile computing device, a smart phone, a one-way pager, a two-way pager, a messaging device, a computer, a personal computer (PC), a desktop computer, a laptop computer, a notebook computer, a handheld computer, a network appliance, and so forth. In some implementations, the meeting consoles 110-1-m may be implemented using a general or specific computing architecture similar to the computing architecture described with reference to FIG. 5.

The meeting consoles 110-1-m may comprise or implement respective client meeting components 112-1-n. The client meeting components 112-1-n may be designed to interoperate with the server meeting component 132 of the multimedia conference server 130 to establish, manage or control a multimedia conference event. For example, the client meeting components 112-1-n may comprise or implement the appropriate application programs and user interface controls to allow the respective meeting consoles 110-1-m to participate in a web conference facilitated by the multimedia conference server 130. This may include input equipment (e.g., video camera, microphone, keyboard, mouse, controller, etc.) to capture media information provided by the operator of a meeting console 110-1-m, and output equipment (e.g., display, speaker, etc.) to reproduce media information by the operators of other meeting consoles 110-1-m. Examples for client meeting components 112-1-n may include without limitation a MICROSOFT OFFICE COMMUNICATOR or the MICROSOFT OFFICE LIVE MEETING Windows Based Meeting Console, and so forth.

As shown in the illustrated embodiment of FIG. 1, the multimedia conference system 100 may include a conference room 150. An enterprise or business typically utilizes conference rooms to hold meetings. Such meetings include multimedia conference events having participants located internal to the conference room 150, and remote participants located external to the conference room 150. The conference room 150 may have various computing and communications resources available to support multimedia conference events, and provide multimedia information between one or more remote meeting consoles 110-2-m and the local meeting console 110-1. For example, the conference room 150 may include a local meeting console 110-1 located internal to the conference room 150.

The local meeting console 110-1 may be connected to various multimedia input devices and/or multimedia output devices capable of capturing, communicating or reproducing multimedia information. The multimedia input devices may comprise any logical or physical device arranged to capture or receive as input multimedia information from operators within the conference room 150, including audio input devices, video input devices, image input devices, text input devices, and other multimedia input equipment. Examples of multimedia input devices may include without limitation video cameras, microphones, microphone arrays, conference telephones, whiteboards, interactive whiteboards, voice-to-text components, text-to-voice components, voice recognition systems, pointing devices, keyboards, touchscreens, tablet computers, handwriting recognition devices, and so forth. An example of a video camera may include a ringcam, such as the MICROSOFT ROUNDTABLE made by Microsoft Corporation, Redmond, Wash. The MICROSOFT ROUNDTABLE is a videoconferencing device with a 360 degree camera that provides remote meeting participants a panoramic video of everyone sitting around a conference table. The multimedia output devices may comprise any logical or physical device arranged to reproduce or display as output multimedia information from operators of the remote meeting consoles 110-2-m, including audio output devices, video output devices, image output devices, text input devices, and other multimedia output equipment. Examples of multimedia output devices may include without limitation electronic displays, video projectors, speakers, vibrating units, printers, facsimile machines, and so forth.

The local meeting console 110-1 in the conference room 150 may include various multimedia input devices arranged to capture media content from the conference room 150 including the participants 154-1-p, and stream the media content to the multimedia conference server 130. In the illustrated embodiment shown in FIG. 1, the local meeting console 110-1 includes a video camera 106 and an array of microphones 104-1-e. The video camera 106 may capture video content including video content of the participants 154-1-p present in the conference room 150, and stream the video content to the multimedia conference server 130 via the local meeting console 110-1. Similarly, the array of microphones 104-1-e may capture audio content including audio content from the participants 154-1-p present in the conference room 150, and stream the audio content to the multimedia conference server 130 via the local meeting console 110-1. The local meeting console may also include various media output devices, such as a display 116 or video projector, to show one or more GUI views with video content or audio content from all the participants using the meeting consoles 110-1-m received via the multimedia conference server 130.

The meeting consoles 110-1-m and the multimedia conference server 130 may communicate media information and control information utilizing various media connections established for a given multimedia conference event. The media connections may be established using various VoIP signaling protocols, such as the SIP series of protocols. The SIP series of protocols are application-layer control (signaling) protocol for creating, modifying and terminating sessions with one or more participants. These sessions include Internet multimedia conferences, Internet telephone calls and multimedia distribution. Members in a session can communicate via multicast or via a mesh of unicast relations, or a combination of these. SIP is designed as part of the overall IETF multimedia data and control architecture currently incorporating protocols such as the resource reservation protocol (RSVP) (IEEE RFC 2205) for reserving network resources, the real-time transport protocol (RTP) (IEEE RFC 1889) for transporting real-time data and providing Quality-of-Service (QOS) feedback, the real-time streaming protocol (RTSP) (IEEE RFC 2326) for controlling delivery of streaming media, the session announcement protocol (SAP) for advertising multimedia sessions via multicast, the session description protocol (SDP) (IEEE RFC 2327) for describing multimedia sessions, and others. For example, the meeting consoles 110-1-m may use SIP as a signaling channel to setup the media connections, and RTP as a media channel to transport media information over the media connections.

In general operation, a schedule device 170 may be used to generate a multimedia conference event reservation for the multimedia conference system 100. The scheduling device 170 may comprise, for example, a computing device having the appropriate hardware and software for scheduling multimedia conference events. For example, the scheduling device 170 may comprise a computer utilizing MICROSOFT OFFICE OUTLOOK® application software, made by Microsoft Corporation, Redmond, Wash. The MICROSOFT OFFICE OUTLOOK application software comprises messaging and collaboration client software that may be used to schedule a multimedia conference event. An operator may use MICROSOFT OFFICE OUTLOOK to convert a schedule request to a MICROSOFT OFFICE LIVE MEETING event that is sent to a list of meeting invitees. The schedule request may include a hyperlink to a virtual room for a multimedia conference event. An invitee may click on the hyperlink, and the meeting console 110-1-m launches a web browser, connects to the multimedia conference server 130, and joins the virtual room. Once there, the participants can present a slide presentation, annotate documents or brainstorm on the built in whiteboard, among other tools.

An operator may use the scheduling device 170 to generate a multimedia conference event reservation for a multimedia conference event. The multimedia conference event reservation may include a list of meeting invitees for the multimedia conference event. The meeting invitee list may comprise a list of individuals invited to a multimedia conference event. In some cases, the meeting invitee list may only include those individuals invited and accepted for the multimedia event. A client application, such as a mail client for Microsoft Outlook, forwards the reservation request to the multimedia conference server 130. The multimedia conference server 130 may receive the multimedia conference event reservation, and retrieve the list of meeting invitees and associated information for the meeting invitees from a network device, such as an enterprise resource directory 160.

The enterprise resource directory 160 may comprise a network device that publishes a public directory of operators and/or network resources. A common example of network resources published by the enterprise resource directory 160 includes network printers. In one embodiment, for example, the enterprise resource directory 160 may be implemented as a MICROSOFT ACTIVE DIRECTORY®. Active Directory is an implementation of lightweight directory access protocol (LDAP) directory services to provide central authentication and authorization services for network computers. Active Directory also allows administrators to assign policies, deploy software, and apply important updates to an organization. Active Directory stores information and settings in a central database. Active Directory networks can vary from a small installation with a few hundred objects, to a large installation with millions of objects.

In various embodiments, the enterprise resource directory 160 may include identifying information for the various meeting invitees to a multimedia conference event. The identifying information may include any type of information capable of uniquely identifying each of the meeting invitees. For example, the identifying information may include without limitation a name, a location, contact information, account numbers, professional information, organizational information (e.g., a title), personal information, connection information, presence information, a network address, a media access control (MAC) address, an Internet Protocol (IP) address, a telephone number, an email address, a protocol address (e.g., SIP address), equipment identifiers, hardware configurations, software configurations, wired interfaces, wireless interfaces, supported protocols, presence information, and other desired information.

The multimedia conference server 130 may receive the multimedia conference event reservation, including the list of meeting invitees, and retrieves the corresponding identifying information from the enterprise resource directory 160. The multimedia conference server 130 may use the list of meeting invitees and corresponding identifying information to assist in identifying the participants to a multimedia conference event. The multimedia conference server 130 may also store and use the identifying information for implementing various recording management techniques.

Once a multimedia conference event is initiated, the one or more meeting consoles 110-1-m may receive media content such as audio/visual (A/V) data from any local media source (e.g., a camera and/or microphone) and can send this media content over the network 120. In one embodiment, there is a distributed object (DO) layer which abstracts signaling stack transactions between the meeting consoles 110-1-m and the multimedia conference server 130. Similarly, conference control and media transactions between the meeting consoles 110-1-m and the multimedia conference server 130 may be abstracted, as will be known by those skilled in the art. The meeting components 112, 134 may be operative for setting up and executing a web meeting, which includes sending and receiving meeting data, such as video and audio media content. Various user interface (UI) control modules may be implemented by the client meeting components 112-1-n at the meeting consoles 110-1-m to allow set up, control and display operations of the system and data. The client meeting components 112-1-n can also process integrated audio such as VOIP signals and PSTN signals.

The client meeting components 112-1-n receive media content from any media source, such as a conventional web camera 106 and microphones 104-1-e. The client meeting components 112-1-n render the media content on the display 116 with integrated or separate speakers. The client meeting components 112-1-n also have various input devices such as a keyboard or mouse. The client meeting components 112-1-n also have a module for receiving and storing various real-time communication (RTC) and meeting media and data transactions and a signaling stack for communicating with the server meeting component 132 of the multimedia conference server 130. In one embodiment, the meeting components 112, 132 communicate via a SIP protocol and an access proxy which interfaces with the signaling stack at the server meeting component 132. As previously described, SIP is an application-layer control (signaling) protocol for creating, modifying, and terminating sessions with one or more participants. These sessions typically include Internet telephone calls, multimedia distribution, and multimedia conferences. It is widely used as signaling protocol for VoIP, along with H.323 and others. Alternately the communication between the meeting components 112, 132 may take place via a secure standard or proprietary protocol such as the Persistent Shared Object Model (PSOM) protocol, although any other protocol for sharing data could be employed.

The multimedia conference server 130 may include a recording management component 134, and the meeting consoles 110-1-m may each optionally implement a respective recording client component 114-1-t. The recording management component 134 and recording client components 114-1-t may operate alone or collectively to implement various enhanced recording management techniques. For example, the recording management component 134 may be arranged for server-side operations while the recording client components 114-1-t may be arranged for client-side operations. Examples of server-side operations may include without limitation scheduling, recording, storing and reproducing a multimedia conference event. Examples of client-side operations may include without limitation scheduling, recording, storing, retrieving recorded meeting events from the multimedia conference server 130, and reproducing recorded meeting events. In the latter case, for example, the recording client component 114-1-t may download selected recorded meeting events for a viewer 156-1-r for viewing at a later time. This may be suitable when the viewer 156-1-r is offline with the multimedia conference server 130, such as when traveling. Although some embodiments may describe the recording management techniques as implemented by the recording management component 134 of the multimedia conference server 130, it may be appreciated that some or all of the recording management techniques may be implemented by one or more of the recording client components 114-2-t. The embodiments are not limited in this context.

More particularly, the recording management component 134 and/or the recording client components 114-1-t implement various auto-attend techniques that allow a meeting invitee to automatically attend a multimedia conference event. A meeting invitee may receive a meeting invite for a multimedia conference event, and find that they are unable or unwilling to accept the meeting invite for any number of different reasons. The meeting invitee, however, may still desire to review the information provided by the multimedia conference event. In this case, the meeting invitee can optionally request that the multimedia conference event be automatically recorded and sent to the meeting invitee.

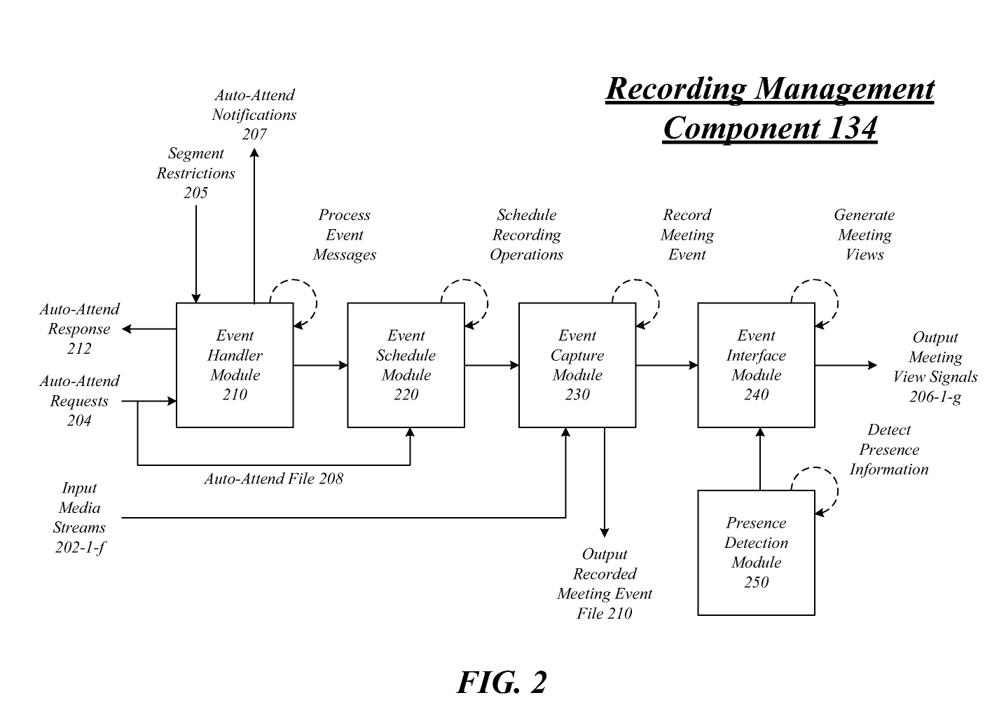

The recording management component 134 may be generally arranged to manage recording and reproduction operations for a multimedia conference event. In one embodiment, the recording management component 134 may comprise an event handler module operative to receive an auto-attend request from a meeting invitee as an auto-attendee for a multimedia conference event. The recording management component 134 may also include an event schedule module communicatively coupled to the event handler module, the event schedule module operative to schedule the multimedia conference event for automatic recording operations in response to the auto-attend request. The recording management component 134 may further include an event capture module communicatively coupled to the event schedule module, the event capture module operative to record the multimedia conference event to form a recorded meeting event file for the auto-attendee. The recording management component 134 may be described in more detail with reference to FIG. 2.

FIG. 2 illustrates a block diagram for the recording management component 134. The recording management component 134 may comprise multiple modules. The modules may be implemented using hardware elements, software elements, or a combination of hardware elements and software elements. Although the recording management component 134 as shown in FIG. 2 has a limited number of elements in a certain topology, it may be appreciated that the recording management component 134 may include more or less elements in alternate topologies as desired for a given implementation. The embodiments are not limited in this context.

In the illustrated embodiment shown in FIG. 2, the recording management component 134 includes an event handler module 210. The event handler module 210 may be generally arranged to handle auto-attend events for the recording management component 134. The event handler module 210 receives an auto-attend request 204 from a meeting console 110-1-m for a meeting invitee requesting to be an auto-attendee for a multimedia conference event. The auto-attend request 204 may include an event identifier to identify a given multimedia conference event. The event handler module 210 may receive the auto-attend request 204, retrieve the event identifier and any user parameters associated with the event identifier, and output the event identifier and associated parameters to the event scheduling module 220.

The associated parameters may include various configurable user parameters set by the meeting invitee requesting to become an auto-attendee for a multimedia conference event. An example for the user parameters may include selections of one or more logical event segments from the multimedia conference event that the auto-attendee would like to record. Logical event segments for the multimedia conference event may be described in more detail below. Other examples for the user parameters may include notification options, such as receiving the recorded meeting event file by a certain communications technique (e.g., email attachment, browser link, etc.), when to send the recorded meeting event file (e.g., during work hours), where to send the recorded meeting event file (e.g., desktop computer, notebook computer, hand-held computer, cellular telephone, etc.), auto-attendee information for presentation or input to the meeting participants 154-1-p, presentation parameters regarding when to provide the auto-attendee information, and so forth. Examples of auto-attendee information may include without limitation auto-attend files, application files, application data, questions, statements, notes, requests, and so forth. It is worthy to note that the auto-attendee information may include media information of various modalities from the auto-attendee, such as text based messages, audio messages, video messages, application documents, and other similar modalities. The embodiments are not limited in this context.

In some cases, the event handler module 210 may need to authenticate the auto-attend request 204. Since the auto-attendee sending the auto-attend request 204 may not necessarily join the multimedia conference event, the authentication operations normally used by the server meeting component 132 of the multimedia conference server 130 to authenticate meeting participants are not performed. If this occurs, the event handler module 210 may need to request the server meeting component 132 to perform authentication operations for the auto-attendee and/or the meeting console 110-1-m used to generate the auto-attend request 204 when received by the recording management component 134. Once authenticated, the event handler module 210 may send the authentication credentials to the event schedule module 220 to allow scheduling of recording operations for the multimedia conference event corresponding to the event identifier.

In some cases, the event handler module 210 may need to authorize the auto-attend request 204. The multimedia conference event corresponding to the event identifier may not be suitable for recording due to a number of reasons. For example, the multimedia conference event may present sensitive and confidential information for a business entity not suitable for recording at all, or at varying levels of security restrictions. In another example, the multimedia conference event may have meeting participants that do not authorize recording of any information provided by the meeting participants. In yet another example, the multimedia conference event may have a meeting participant that is geographically located in a jurisdiction, state or country with certain legal requirements restricting the recordation of the meeting participant. Other recording restrictions for the auto-attendee, the meeting participants, or the communications system 100 may apply as well.

The multimedia conference event may be separated into logical event segments, with each logical event segment representing a portion of the multimedia conference event. The logical event segments may be temporal, thereby separating the multimedia conference event into separate time event segments. The logical event segments may be spatial, thereby separating the multimedia conference event based on geographic location. The logical event segments may be personal, thereby separating the multimedia conference event into separate meeting attendee segments. The logical event segments may be informational, thereby separating the multimedia conference event into separate information category segments. The logical event segments may be business related, thereby separating the multimedia conference event into separate business category segments. The various logical event segments and associated restrictions may be stored as segment restrictions 205. The number and granularity of the logical event segments may vary according to a specific implementation, and the embodiments are not limited in this context.

The event handler module 210 may receive the auto-attend request 204 and the segment restrictions 205. The event handler module 210 may determine whether to grant or deny the auto-attend request 204 received from the auto-attendee for some or all logical event segments of the multimedia conference event. The event handler module 210 may determine to grant or deny the auto-attend request 204 for the entire multimedia conference event or on a segment-by-segment basis. In the latter case, the event handler module 210 may authorize recording for some logical event segments while denying recording for other logical event segments. For example, the event handler module 210 may compare the user parameters with selections to record certain logical event segments with the segment restrictions 205, and set recording permissions accordingly. The event handler module 210 may then send an auto-attend response 212 indicating whether the auto-attend request 204 has been granted or denied for some or all of the logical event segments to the meeting console 110-1-m of the auto-attendee.

The event handler module 210 may be further operative to send an auto-attendee list to selected entities, such as a meeting organizer for the multimedia conference event, the meeting invitees for a multimedia conference event, and so forth. Once the event handling module 210 sets recording permissions in response to the auto-attend request 204, and sends out the auto-attend response 212 informing the auto-attendee of the recording permissions, the event handler module 210 may publish the auto-attendee list to the selected entities via auto-attend notifications 207. This may be advantageous for a number of reasons. For example, a meeting invitee may determine whether they are going to attend or auto-attend the multimedia conference event based in part on which meeting invitees will be actually attending the multimedia conference event. In another example, a meeting invitee may realize an auto-attendee should be present for the multimedia conference event, and notify the auto-attendee accordingly. In yet another example, a meeting organizer or meeting invitee may choose to modify the recording permissions set by the event handler module 210.

The recording management component 134 may also include the event schedule module 220 communicatively coupled to the event handler module 210. The event schedule module 220 is generally arranged to schedule the multimedia conference event for automatic recording operations in response to the auto-attend request 204 and permissions provided by the event handler module 210. The event schedule module 220 schedules a time and date for when to begin recording the multimedia conference event, and which logical event segments of the multimedia conference event to record based on a recording schedule. The recording schedule may be generated based on the permissions given by the event handler module 210.

In addition to scheduling recording operations, the event schedule module 220 is operative to receive information for presentation to the meeting participants 154-1-p during the multimedia conference event as defined by the user parameters associated with the auto-attend request 204. In one embodiment, for example, the event schedule module 220 may receive an auto-attend file 208 from the auto-attendee for presentation during the meeting on behalf of the auto-attendee. The auto-attend file 208 may comprise an attachment to the auto-attend request 204. The auto-attend file 208 may comprise any information suitable for presentation during the multimedia conference event, such as an application program, application data for an application program, presentation slides, word processing documents, spreadsheet documents, and so forth.

The event schedule module 220 may build into the recording schedule when the auto-attend file 208 should be made available to the meeting participants 154-1-p. The auto-attend file 208 may include one or more presentation parameters representing when the auto-attend file 208 should be presented to the meeting participants during the multimedia conference event. For example, the presentation parameters may specify certain logical event segments suitable for introducing the auto-attend file 208 (e.g., agenda item1), context indicators suitable to trigger presentation of the auto-attend file 208 (e.g., presence of a certain meeting participant 154-1-p), explicit requests from a meeting participant 154-1-p, implicit requests from a meeting participant 154-1-p (e.g., question on topic), and so forth. The embodiments are not limited in this context.

The recording management component 134 may further include an event capture module 230 communicatively coupled to the event schedule module 220. The event capture module 230 is generally arranged to record the multimedia conference event to form a recorded meeting event file for the auto-attendee. The event capture module 230 operative to record a multimedia conference event to form a recorded meeting event. Recorded meeting events may be defined by a spectrum ranging from as-is recordings to fully scripted recordings. In as-is recordings, data is preserved as is with no editing or broad distribution. This type of recording is typically used for preserving important conversations, offline note-taking or for legal compliance in corporate environments. This data is hardly distributed, if at all and has low subsequent usage. Fully scripted recordings, on the other hand, may use the recording process only as a first step or a baseline starting point. The data is then edited (sometimes iteratively) to create a fully polished presentation or training material that is broadly distributed. Everything else in web conferencing recording, such as the typical missed meeting scenario, falls in between.

The event capture module 230 may be arranged to record or capture media content from a multimedia conference event, such as a web meeting, conference or training session. The event capture module 230 receives various input media streams 202-1-f from the various meeting consoles 110-1-m. The media streams 202-1-f may include, among other information, meeting data to include meeting content (e.g., presentations, images, spreadsheets, documents), generated data content (annotations, whiteboard, text slides, questions and answers (Q&A), shared notes and so on), audio and video from the meeting, meeting attendee information, and so forth. In one embodiment, for example, the event capture module 230 may record event communications between participants of the multimedia conference event. The event communications may include Q&A, presentation materials, and other shared notes communicated between the participants 154-1-p during the multimedia conference event.

The event capture module 230 may support various recording output formats, including a screen capture (or scraping format) and per-audio slide format, among others. The screen scraping format encodes all data and audio in the meeting to a single video file for playback from a streaming server or a local directory. This is the most widely used format employed today. Basic per-slide audio format is a low fidelity format that converts the final view of most slide types into static images with audio narration. Additionally or alternatively, the event capture module 230 may further include multi-track support wherein tracks in different formats are available for selection. Each track is independent from the other tracks and operates in parallel. That is, each of the data sources (e.g., the audio, video or meeting content in various formats for the meeting or any sub-meeting) is considered as a different track which can be separately replayed and edited. The event capture module 230 is capable of capturing panoramic video if one of the inputs is from the omni-directional camera 106 and the microphone array 104-1-e.

In addition to performing event recording operations, the event capture module 230 may also perform publishing operations for the recorded meeting events. In one embodiment, for example, the event capture module 230 may convert the captured data into a universal format that can be rendered readily by the playback module. One embodiment of the interactive recording, access and playback technique employs a high fidelity presentation (HFP) format publisher. The HFP publisher uses the HFP format, which is discussed in greater detail below. The publishing process automatically generates data in a format that an end user can use with only a browser and a media player. The event capture module 230 may also perform transcoding operations to convert certain captured data formats into different data formats suitable for publishing if necessary. The publishing process further includes publishing the data in a universal format and produces the multiple indices employed by the event capture module 230. It also is responsible for panoramic image production. Lastly, the publishing process includes post-processing operations employed in post processing data to clean up temporary data files.

In the illustrated embodiment shown in FIG. 2, the event capture module 230 may be implemented as part of the recording management component 134 of the multimedia conference server 130. In this case, the event capture module 230 may perform server-side recording operations for a multimedia conference event. Server-side recording is a recording model where media content is captured and published on the multimedia conference server 130, thereby eliminating the need for higher system requirements on the meeting consoles 110-1-m and know-how of an operator. Due to the central nature of server-side recording, it is a typically a shared experience. It is the single recording of the multimedia conference event from the perspective of the multimedia conference server 130. Hence, when one presenter changes the recording controls, all presenters will see the change. There is typically one server-side recording instance of a multimedia conference event at any given time.

Additionally or alternatively, the event capture module 230 may be implemented as part of the recording client component 114. In this case, the event capture module 230 may perform client-side recording operations. Client-side recording is a recording model where media content is captured and published on a meeting console 110-1-m. It gives the operator more control over his or her data, since no recordings data is preserved on the multimedia conference server 130. Due to the client centric nature of client-side recording, however, it is typically an individual experience. Each user's recording is separate and unique, and is a reflection of what that user desires to capture in the meeting. Any changes to recording settings, therefore, are applicable only on that client and do not impact any other user.

The event capture module 230 may also receive control directives during a multimedia conference event from a meeting participant 154-1-p. The control directives may request modification of the recording permission set for one or more auto-attendees. For example, a meeting participant 154-1-p may desire to stop recording of a logical event segment of the multimedia conference event for any number of reasons, such as discussions of a confidential or sensitive nature. The event capture module 230 may receive the control directives, and modify its recording operations accordingly.

Once the event capture module 230 records the multimedia conference event to form the recorded meeting event file 209, it notifies the event handler module 210. The event handler module 210 sends an auto-attend complete message indicating completion of the recorded meeting event to the auto-attendee. In one embodiment, the auto-attend complete message may include the actual recorded meeting event file 209. In one embodiment, for example, the auto-attend complete message may include a link or pointer to the recorded meeting event file 209 stored by the multimedia conference server 130, or some other network device accessible by the meeting console 110-1-m for the auto-attendee.

The recording management component 134 may further include the event interface module 240 communicatively coupled to the event capture module 230. The event interface module 240 is generally arranged to facilitate the exchange of information between the auto-attendees, the meeting participants 154-1-p, and the recording management component 134. The event interface module 240 may generate various GUI information, elements and views for interfacing with an operator of a meeting console 110-1-m, such as the meeting participants 154-1-p.

The event interface module 240 may be further operative to output meeting view signals 206-1-g that can be used to render the meeting view 108. The meeting view 108 may include, among other information, an auto-attendee list suitable for display to the meeting participants 154-1-p during the multimedia conference event. In this manner, the meeting participants 154-1-p will be able to quickly determine the number and identities for the auto-attendees.

In addition to the list of auto-attendees, the event interface module 240 may be operative to generate the meeting view 108 to display presence information for the auto-attendees. The recording management component 134 may further include a presence detection module 250. The presence detection module 250 may be generally arranged to monitor and retrieve presence information for various entities associated with the multimedia conference event, including the auto-attendees. The presence detection module 250 may retrieve published presence information for the various entities from a number of different network sources, including a presence server, a presentity node, the enterprise resource directory 160, and so forth. For example, a presence server may publish presence state information to indicate a current communication status for a presentity. The term “presentity” may refer to an entity described by presence information. This published presence state information informs others that desire to contact the presentity of his/her availability and willingness to communicate. A common use of presence state information is to display an indicator icon on a communication application, such as an instant messaging (IM) client. The indicator icon may comprise a graphic symbol corresponding with an easy-to-convey meaning, and a list of corresponding text descriptions for each of the states. Examples of such text descriptions may include “free for chat,” “busy,” “away,” “do not disturb,” “out to lunch” and so forth. Such presence states exist in many variations across different communications clients. Current standards typically support a rich choice of additional presence attributes that can be used for presence information, such as user mood, location, or free text status.

The presence detection module 250 may retrieve presence information for the auto-attendees, and forward the presence information to the event interface module 240. The event interface module 240 may include the presence information for the auto-attendees in the output meeting view signals 206-1-g used for the meeting view 108. When the auto-attendee presence information is displayed during the multimedia conference event, the meeting participants 154-1-p may determine whether an auto-attendee is available to communicate during the multimedia conference event. For example, a meeting participant 154-1-p may have a question for the auto-attendee, and review the auto-attendee presence information for the auto-attendee. If the auto-attendee presence information indicates that the auto-attendee if is available for communication by a certain communications modality (e.g., email, IM, chat, voice, device, etc.), the meeting participant 154-1-p can establish a communication channel using the appropriate communications modality, and engage in interactive communications with the auto-attendee.

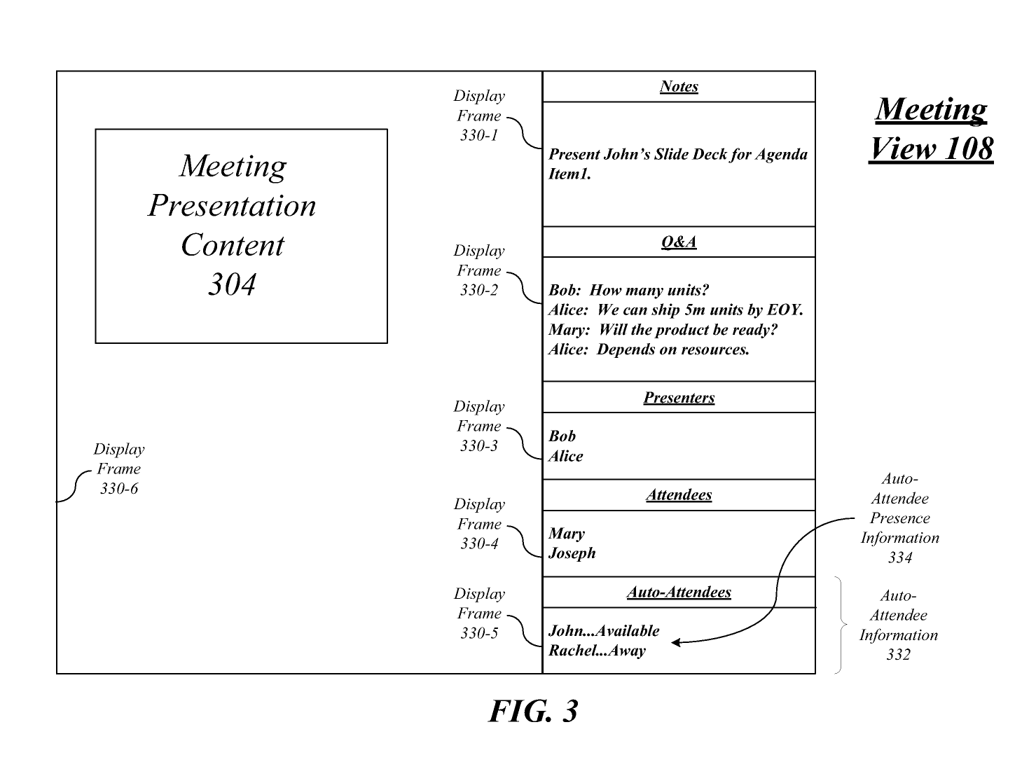

FIG. 3 illustrates a more detailed diagram of the meeting view 108. The meeting view 108 may comprise various display frames 330-1-a arranged in a certain mosaic or display pattern for presentation to meeting participants 154-1-p, such as an operator of a meeting console 110-1-m. Each display frame 330-1-a is designed to render or display multimedia content from the media streams 202-1-f such as video content and/or audio content from a corresponding media stream 202-1-f mapped to a given display frame 330-1-a.

In the illustrated embodiment shown in FIG. 3, for example, the meeting view 108 may include a display frame 330-6 comprising a main viewing region to display a meeting presentation content 304 for the multimedia conference event, such as a set of presentation slides, video of a speaker, whiteboard drawings, and any other multimedia content desired for the multimedia conference event.

Further, the meeting view 108 may include the display frames 330-1 through 330-5 to render or display various types of GUI elements, such as participant contact information and presence information, viewer contact information and presence information, Q&A sessions, notes and so forth. It may be appreciated that the meeting view 108 may include more or less display frames 330-1-a of varying sizes and alternate arrangements as desired for a given implementation.

The meeting view 108 may comprise multiple display frames 330-1 through 330-5. The display frames 330-1 through 330-4 may provide various types of information associated with participants 154-1-p. In the illustrated embodiment shown in FIG. 3, the various display frames 330-1-4 may be located in a predetermined order from a top of meeting view 108 to a bottom of meeting view 108, such as the display frame 330-1 at a first position near the top, the display frame 330-2 in a second position, the display frame 330-3 in a third position, and the display frame 330-4 in a fourth position near the bottom. It may be appreciated, however, that the display frames 330-1-4 and associated media content may be in any sequence as desired for a given implementation.

The display frames 330-1-4 may be used to display various types of information about the meeting presentation content 304 that allow the participants 154-1-p to dynamically interact with each other in the context of the multimedia conference event. For example, the display frame 330-1 may include a GUI element allowing a participant 154-1-p to display notes associated with the meeting presentation content 304. The notes may be personal notes for private consumption or published notes for the viewing community.

The display frame 330-2 may include a GUI element representing a Q&A session for the meeting presentation content 304. The Q&A session may include the Q&A communications made during the multimedia conference event. The Q&A pane shows the questions and answers presented during the multimedia conference event (e.g., a web conferencing or live meeting). For example, a meeting participant 154-1-p may desire to ask a question for a presenter, and the questions may be queued for the presenter in a certain priority order, such as when received, by meeting participant 154-1-p, by urgency, and so forth.

The display frames 330-3, 330-4 and 330-5 may be used to display information for various entities associated with the multimedia conference event. For example, the display frame 330-3 may include a list of presenters for the multimedia conference event. The display frame 330-4 may include a list of attendees for the multimedia conference event. The display frame 330-5 may include auto-attendee information 332, such as a list of auto-attendees for the multimedia conference event.

The display frame 330-5 may further display auto-attendee presence information 334 for the list of auto-attendees. The auto-attendee presence information 334 may include presence state information indicating whether an auto-attendee is available for communication by a certain communications modality during the multimedia conference event. When appropriate, the meeting participants 154-1-p may use the presence information to communicate with the auto-attendee by the indicated communications modality. The auto-attendee presence information 334 may be dynamic and change as the status of the various entities change (e.g., online, away, busy, office, home, etc.).

Operations for the above-described embodiments may be further described with reference to one or more logic flows. It may be appreciated that the representative logic flows do not necessarily have to be executed in the order presented, or in any particular order, unless otherwise indicated. Moreover, various activities described with respect to the logic flows can be executed in serial or parallel fashion. The logic flows may be implemented using one or more hardware elements and/or software elements of the described embodiments or alternative elements as desired for a given set of design and performance constraints. For example, the logic flows may be implemented as logic (e.g., computer program instructions) for execution by a logic device (e.g., a general-purpose or specific-purpose computer).

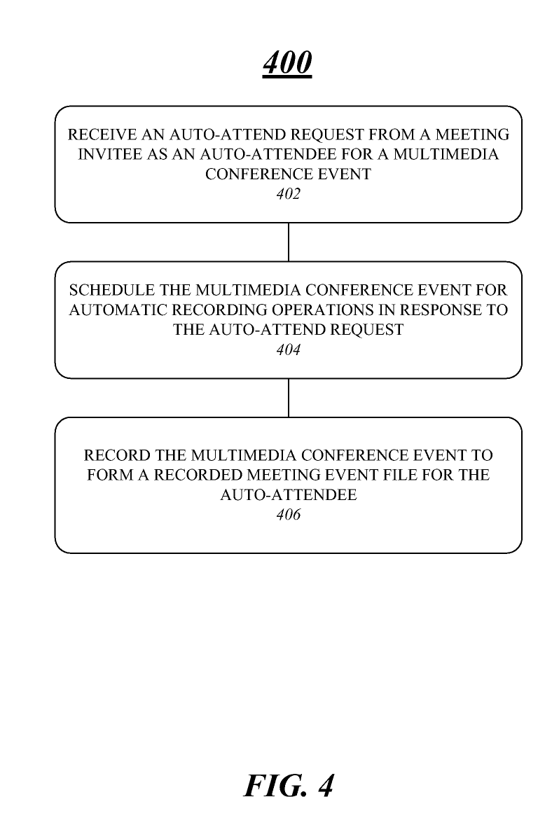

FIG. 4 illustrates one embodiment of a logic flow 400. Logic flow 400 may be representative of some or all of the operations executed by one or more embodiments described herein.

As shown in FIG. 4, the logic flow 400 may receive an auto-attend request from a meeting invitee as an auto-attendee for a multimedia conference event at block 402. For example, the event handler module 210 of the recording management component 134 receives the auto-attend request 204 from a meeting invitee as an auto-attendee for a multimedia conference event. The auto-attend request 204 may include a request to automatically record some or all of the multimedia conference event on behalf of the auto-attendee. The auto-attend request 204 may include, among other information, an event identifier for the multimedia conference event, user parameters, auto-attend files, and so forth.

The logic flow 400 may schedule the multimedia conference event for automatic recording operations in response to the auto-attend request at block 404. For example, the event schedule module 220 of the recording management component 134 may schedule the multimedia conference event for automatic recording operations in response to the auto-attend request. The event schedule module 220 may set a start date and time to begin recording the multimedia conference event, and which logical event segments to record as set forth in a recording schedule. The scheduled recording operations may dynamically change in response to changes in the meeting invite for the multimedia conference event.

The logic flow 400 may record the multimedia conference event to form a recorded meeting event file for the auto-attendee at block 406. For example, the event capture module 230 of the recording management component 134 may record the multimedia conference event to form a recorded meeting event file for the auto-attendee. The recorded meeting event file, or a link to the recorded meeting event file, may then be sent to the auto-attendee at the end of the multimedia conference event, or some other scheduled time.

FIG. 5 further illustrates a more detailed block diagram of computing architecture 510 suitable for implementing the meeting consoles 110-1-m or the multimedia conference server 130. In a basic configuration, computing architecture 510 typically includes at least one processing unit 532 and memory 534. Memory 534 may be implemented using any machine-readable or computer-readable media capable of storing data, including both volatile and non-volatile memory. For example, memory 534 may include read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, or any other type of media suitable for storing information. As shown in FIG. 5, memory 534 may store various software programs, such as one or more application programs 536-1-t and accompanying data. Depending on the implementation, examples of application programs 536-1-t may include the client meeting component 112, the server meeting component 132, the recording client component 114, the recording management component 134, and so forth.

Computing architecture 510 may also have additional features and/or functionality beyond its basic configuration. For example, computing architecture 510 may include removable storage 538 and non-removable storage 540, which may also comprise various types of machine-readable or computer-readable media as previously described. Computing architecture 510 may also have one or more input devices 544 such as a keyboard, mouse, pen, voice input device, touch input device, measurement devices, sensors, and so forth. Computing architecture 510 may also include one or more output devices 542, such as displays, speakers, printers, and so forth.

Computing architecture 510 may further include one or more communications connections 546 that allow computing architecture 510 to communicate with other devices. Communications connections 546 may include various types of standard communication elements, such as one or more communications interfaces, network interfaces, network interface cards (NIC), radios, wireless transmitters/receivers (transceivers), wired and/or wireless communication media, physical connectors, and so forth. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired communications media and wireless communications media. Examples of wired communications media may include a wire, cable, metal leads, printed circuit boards (PCB), backplanes, switch fabrics, semiconductor material, twisted-pair wire, co-axial cable, fiber optics, a propagated signal, and so forth. Examples of wireless communications media may include acoustic, radio-frequency (RF) spectrum, infrared and other wireless media. The terms machine-readable media and computer-readable media as used herein are meant to include both storage media and communications media.

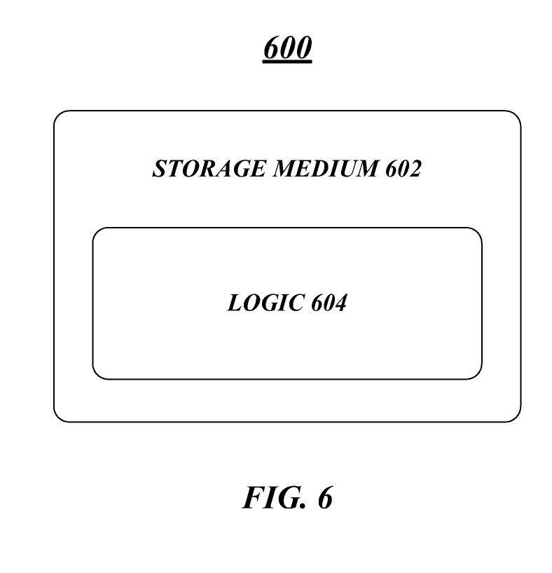

FIG. 6 illustrates a diagram an article of manufacture 600 suitable for storing logic for the various embodiments, including the logic flow 400. As shown, the article of manufacture 600 may comprise a storage medium 602 to store logic 604. Examples of the storage medium 602 may include one or more types of computer-readable storage media capable of storing electronic data, including volatile memory or non-volatile memory, removable or non-removable memory, erasable or non-erasable memory, writeable or re-writeable memory, and so forth. Examples of the logic 604 may include various software elements, such as software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof.

In one embodiment, for example, the article of manufacture 600 and/or the computer-readable storage medium 602 may store logic 604 comprising executable computer program instructions that, when executed by a computer, cause the computer to perform methods and/or operations in accordance with the described embodiments. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain function. The instructions may be implemented using any suitable high-level, low-level, object-oriented, visual, compiled and/or interpreted programming language, such as C, C++, Java, BASIC, Perl, Matlab, Pascal, Visual BASIC, assembly language, and others.

Various embodiments may be implemented using hardware elements, software elements, or a combination of both. Examples of hardware elements may include any of the examples as previously provided for a logic device, and further including microprocessors, circuits, circuit elements (e.g., transistors, resistors, capacitors, inductors, and so forth), integrated circuits, logic gates, registers, semiconductor device, chips, microchips, chip sets, and so forth. Examples of software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still cooperate or interact with each other.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method, comprising:
receiving an auto-attend request from a meeting invitee as an auto-attendee for a multimedia conference event;
scheduling the multimedia conference event for automatic recording operations in response to the auto-attend request; and
recording the multimedia conference event to form a recorded meeting event file for the auto-attendee.

2. The method of claim 1, comprising receiving an auto-attend file from the auto-attendee for presentation during the meeting on behalf of the auto-attendee.

3. The method of claim 1, comprising sending an auto-attendee list to the meeting invitees for the multimedia conference event.

4. The method of claim 1, comprising displaying an auto-attendee list to meeting participants for the multimedia conference event.

5. The method of claim 1, comprising displaying presence information for an auto-attendee to meeting participants for the multimedia conference event.

6. The method of claim 1, comprising determining whether to grant or deny the auto-attend request received from the auto-attendee for some or all logical event segments of the multimedia conference event.

7. The method of claim 1, comprising sending an auto-attend response indicating whether the auto-attend request has been granted or denied to the auto-attendee.

8. The method of claim 1, comprising sending an auto-attend complete message indicating completion of the recorded meeting event to the auto-attendee.

9. The method of claim 1, comprising sending an auto-attend complete message indicating completion of the recorded meeting event to the auto-attendee, the auto-attend complete message having the recorded meeting event file.

10. The method of claim 1, comprising sending an auto-attend complete message indicating completion of the recorded meeting event to the auto-attendee, the auto-attend complete message having a pointer to the recorded meeting event file stored by a multimedia conference server.

11. An article comprising a storage medium containing instructions that if executed enable a system to:
receive an auto-attend request from a meeting invitee as an auto-attendee for a multimedia conference event;
schedule the multimedia conference event for automatic recording operations in response to the auto-attend request;
record the multimedia conference event to form a recorded meeting event file for the auto-attendee; and
send an auto-attend complete message indicating completion of the recorded meeting event to the auto-attendee.

12. The article of claim 11, further comprising instructions that if executed enable the system to send the auto-attend complete message with the recorded meeting event file or a pointer to the recorded meeting event file stored by a network device.

13. The article of claim 11, further comprising instructions that if executed enable the system to receive an auto-attend file from the auto-attendee for presentation during the meeting on behalf of the auto-attendee.

14. The article of claim 11, further comprising instructions that if executed enable the system to display an auto-attendee list to meeting participants for the multimedia conference event.

15. The article of claim 11, further comprising instructions that if executed enable the system to determine whether to grant or deny the auto-attend request received from the auto-attendee for some or all logical event segments of the multimedia conference event.

16. An apparatus, comprising:
a recording management component operative to manage recording and reproduction operations for a multimedia conference event, the recording management component comprising:
an event handler module operative to receive an auto-attend request from a meeting invitee as an auto-attendee for a multimedia conference event;
an event schedule module communicatively coupled to the event handler module, the event schedule module operative to schedule the multimedia conference event for automatic recording operations in response to the auto-attend request; and
an event capture module communicatively coupled to the event schedule module, the event capture module operative to record the multimedia conference event to form a recorded meeting event file for the auto-attendee.

17. The apparatus of claim 16, the event schedule module operative to receive an auto-attend file from the auto-attendee for presentation during the meeting on behalf of the auto-attendee.

18. The apparatus of claim 16, the event handler module operative to determine whether to grant or deny the auto-attend request received from the auto-attendee for some or all logical event segments of the multimedia conference event, and send an auto-attend response indicating whether the auto-attend request has been granted or denied for some or all of the logical event segments to the auto-attendee.

19. The apparatus of claim 16, the event handler module operative to send an auto-attend complete message indicating completion of the recorded meeting event to the auto-attendee, the auto-attend complete message having the recorded meeting event file or a pointer to the recorded meeting event file stored by a multimedia conference server.

20. The apparatus of claim 16, comprising an event interface module communicatively coupled to the event capture module, the event interface module operative to display an auto-attendee list and presence information for an auto-attendee to meeting participants for the multimedia conference event.
